(19) United States
(12) Patent Application Publication
(10) Pub. No.: US 2023/0129086 A1
(43) Pub. Date: Apr. 27, 2023

(54) A HOLOGRAM ELEMENT FOR BROADBAND SHAPING OF ELECTROMAGNETIC WAVES AND A RELATED SYSTEM

(71) Applicant: AALTO UNIVERSITY FOUNDATION SR, Aalto (FI)

(72) Inventor: Aleksi TAMMINEN, Aalto (FI)

(21) Appl. No.: 17/912,442

(22) PCT Filed: Mar. 19, 2021
(86) PCT No.: PCT/FI2021/050196

§ 371 Date: Sep. 16, 2022

(30) Foreign Application Priority Data
Mar. 19, 2020 (FI) 20205284

(51) Int. Cl. H01Q 19/06; G02B 5/32; G02B 27/09; H01Q 15/08; G01S 13/89; G01S 7/03; H01Q 3/36

(52) U.S. Cl. CPC H01Q 19/067; G02B 5/32; G02B 27/0944; H01Q 15/08; G01S 13/89; G01S 7/03; H01Q 3/36

(57) ABSTRACT

A hologram element for broadband shaping of electromagnetic waves and a related system are disclosed. The hologram element has a dispersive surface with a surface height profile that is configured to spatially modulate at least one of an amplitude or a phase of transmitted electromagnetic waves having a bandwidth defined by a start frequency f₁ and a stop frequency f₂. The surface height profile is further configured to maximize a rate of one of a phase shift or a delay variation at said bandwidth via steps comprised in the dispersive surface, each step having a step height the electrical length of which is a multiple of N+q wavelengths at the start frequency f₁ and M multiple of wavelengths at the stop frequency f₂.

### TECHNICAL FIELD

The present disclosure relates to the field of beamforming, and, more particularly, to a hologram element for broadband shaping of electromagnetic waves and to related systems.

### BACKGROUND

Partial transparency to common materials and high sensitivity to water content are properties that drive millimeter- and submillimeter-wave imaging technology forward. In addition to numerous scientific applications, imaging is used e.g. in personnel screening, medical diagnosis, and non-destructive testing. Submillimeter wavelength enables high-resolution imagery up to few meters with a practical sized footprint. Many of the applications require real-time imagery, which leads to a pressure to increase sensor count or opto-mechanics complexity. Despite of significant advances in transceiver development, the unit cost for a sensor at this bandwidth remains high.

The image-forming technologies used in submillimeter-wave real-time screening systems are based on electrical or mechanical scanning of the beam. Typically, there is a quasi-optical arrangement with focal points on an object and a sensor. The focal point on the object is steered by, e.g., a flat mirror attached to mechanical drives. Other imaging systems may apply sensor arrays or reflectarrays with a controllable phase shift so that the beam can be steered without massive moving physical elements. Phase shift can also be applied post detection in a multi-sensor system when the imaging is carried out by computational means.

Currently, both the mechanically and electrically scanned imaging systems involve complex solutions that may have a limited life span and that necessarily increase the cost and the system footprint. Imaging systems with electrical beam steering may include thousands of sensors operating in a coherent way. Although the cost of transceiver technology at millimeter waves has come down thanks to mass production for telecommunications and automotive radars, the technology still remains prohibitively expensive, especially at higher millimeter wave frequencies and at submillimeter wave frequencies.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a hologram element for broadband shaping of electromagnetic waves has a dispersive surface with a surface height profile that is configured to spatially modulate at least one of an amplitude or a phase of transmitted electromagnetic waves having a bandwidth defined by a start frequency f₁ and a stop frequency f₂.

The surface height profile is further configured to maximize a rate of one of a phase shift or a delay variation at the bandwidth via steps comprised in the dispersive surface, each step having a step height the electrical length of which is a multiple of N+q wavelengths at the start frequency f₁ and M multiple of wavelengths at the stop frequency f₂, such that:

M=(f₂/f₁)(N+q)=2(N+q),3(N+q),4(N+q)

in which q is a rational number representing a quantization step, and N is an integer.

In an example embodiment, alternatively or in addition to the above-described example embodiments, the surface height profile is further configured such that the phase shift or delay variation is multiples of wavelengths different at different locations in order to allow the spatial modulation of the at least one of the amplitude or the phase of the transmitted electromagnetic waves having the bandwidth.

In an example embodiment, alternatively or in addition to the above-described example embodiments, the surface height profile is further configured to facilitate transmitting the spatially modulated electromagnetic waves towards a region of interest within the bandwidth.

In an example embodiment, alternatively or in addition to the above-described example embodiments, the surface height profile is further configured to facilitate transmitting the spatially modulated electromagnetic wave towards a region of interest such that the electromagnetic waves are uniquely dependent on one of frequency or time at each location in the region of interest.

In an example embodiment, alternatively or in addition to the above-described example embodiments, the hologram element is of a transmission type or a reflection type.

In an example embodiment, alternatively or in addition to the above-described example embodiments, the electromagnetic waves comprise radio waves in a millimeter wave band or in a submillimeter wave band.

In an example embodiment, alternatively or in addition to the above-described example embodiments, the electromagnetic waves comprise a frequency sweep or a pulse radiating across the bandwidth.

An example embodiment of a system comprises the hologram element according to any of the above-described example embodiments. The system further comprises a transceiver configured to transmit the electromagnetic waves towards the hologram element and to receive the spatially modulated electromagnetic waves reflected from an object in the region of interest. The electromagnetic field of the reflected spatially modulated electromagnetic waves is dependent on at least one of time or frequency in a way characteristic to a shape and reflectivity of the object in the region of interest.

In an example embodiment, alternatively or in addition to the above-described example embodiments, the system further comprises a computer program product comprising program code configured to determine a reflectivity image of the object in the region of interest based on the received reflected spatially modulated electromagnetic waves.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2 shows an example embodiment of the subject matter described herein illustrating a cross-section of a hologram element;

FIG. 3A shows an example embodiment of the subject matter described herein illustrating a height profile of a hologram element; and

FIG. 3B shows an example embodiment of the subject matter described herein illustrating a perspective view of a hologram element.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In the following, various example embodiments will be discussed. At least some of these example embodiments may allow broadband shaping of electromagnetic waves.

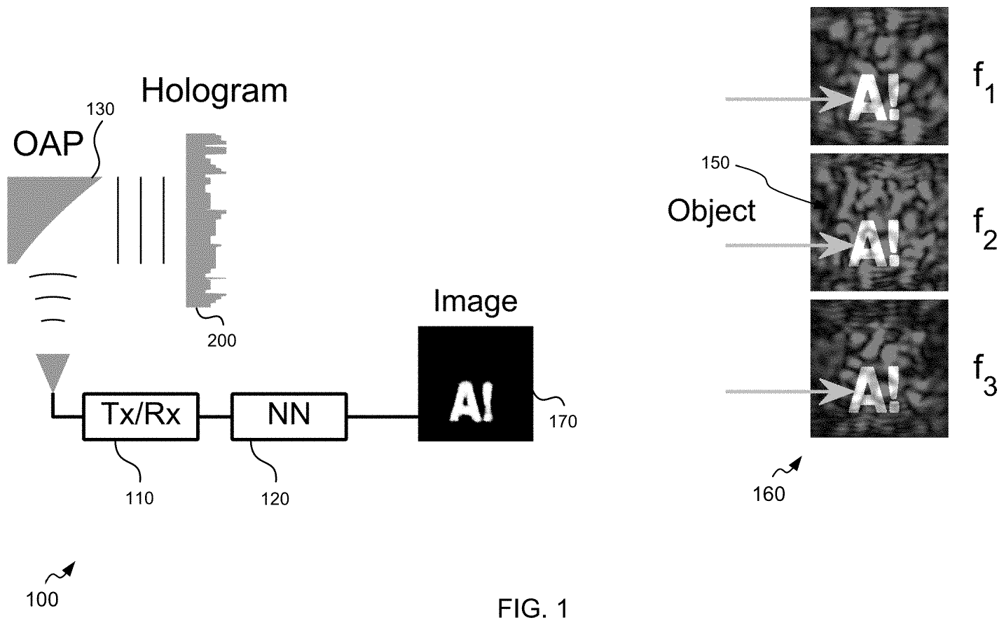

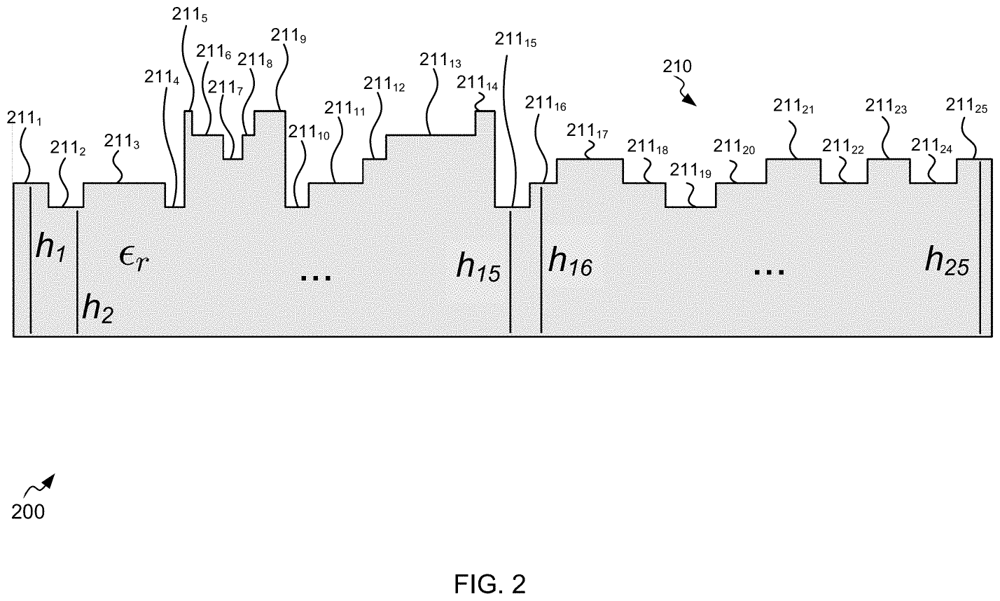

FIG. 1 illustrates an example system 100 (e.g. an imaging and/or localization system), where various embodiments of the present disclosure may be implemented. The system 100 may be utilized in imaging and/or localization e.g. in personnel screening, medical diagnosis (such as determining water content of a tissue), non-destructive testing, and/or inspecting thin film thicknesses, such as in an automobile paint surface in an automobile factory. The system 100 comprises a hologram element 200 that will be described in more detail in connection with FIG. 2. The system 100 further comprises a transceiver 110 that is configured to transmit or emit electromagnetic waves (e.g. wideband electromagnetic radiation) towards the hologram element 200 and to receive the spatially modulated electromagnetic waves (spatially modulated by the hologram element 200 as will be described in more detail in connection with FIG. 2) that are reflected from an object 150 in a region of interest. The electromagnetic field of the reflected spatially modulated electromagnetic waves is dependent on at least one of time or frequency in a way that is characteristic to a shape and reflectivity of the object 150 in the region of interest.

The system may further comprise a computer program product 120 comprising program code that is configured to determine a reflectivity image 170 of the object 150 in the region of interest based on the received reflected spatially modulated electromagnetic waves. The computer program product 120 may comprise e.g. a neural network, NN, that is trained to produce the reflectivity image or localization information of the object at the given wavelength range.

In other words, when the transceiver 110 carries out e.g. a frequency sweep or emits a pulse, electromagnetic radiation is emitted through the hologram element 200 towards the object 150, thus distributing on the object 150 in multiple radiation patterns. The radiation reflects from the object 150 back to the transceiver 110, the radiation is detected, and the values at each frequency or at each time may be input to the computer program product 120. As described above, the computer program product 120 may comprise e.g. a neural network that is trained to produce the reflectivity image or localization information of the object at the given wavelength range.

The system may further comprise a mirror element (e.g. an off-axis parabolic, OAP, mirror element) 130 or the like via which the electromagnetic waves are emitted towards the hologram element 200.

Images 160 illustrate how radiation patterns are different at different frequencies f₁-f₃ at the object 150.

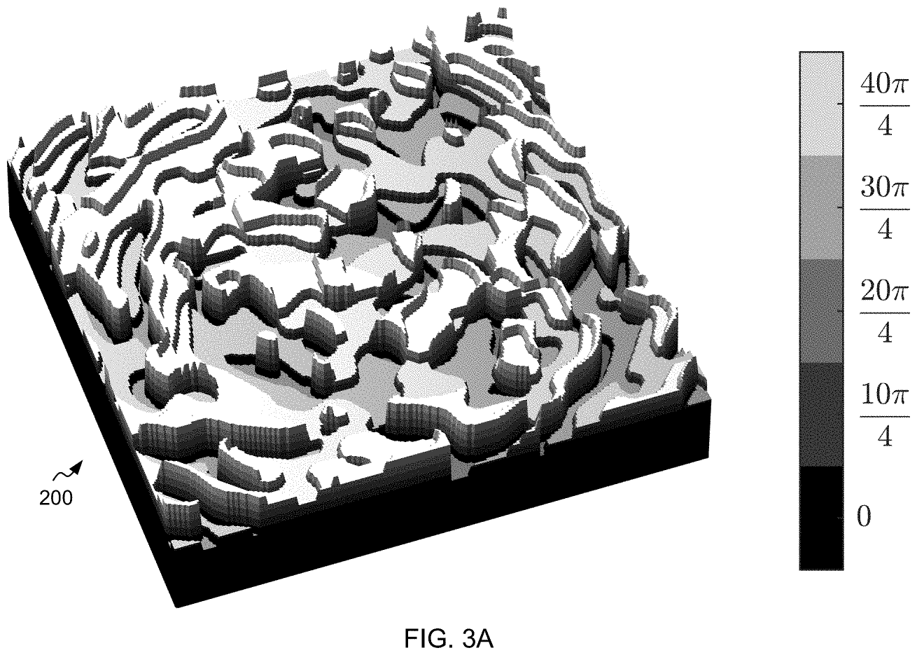

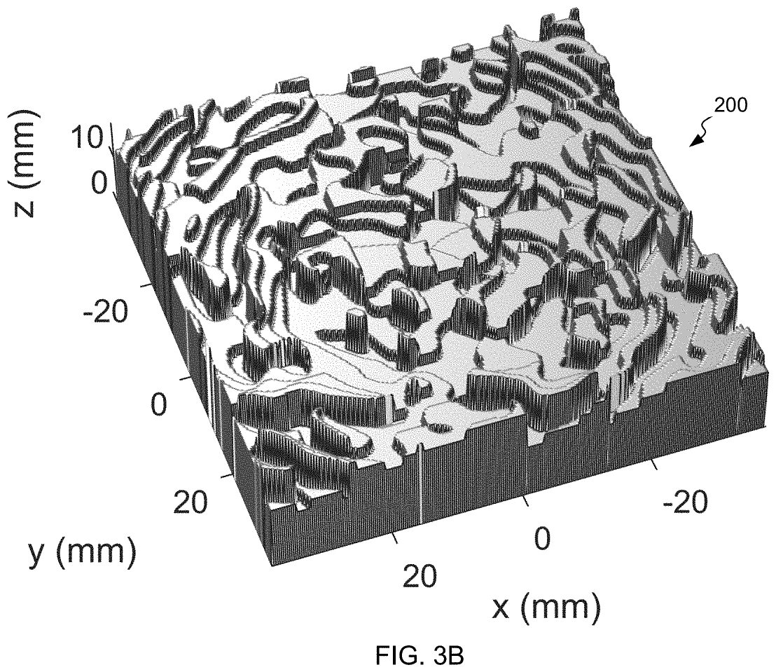

FIG. 2 is a cross-section of the hologram element 200, FIG. 3A is an example height profile of the hologram element 200, and FIG. 3B is a perspective view of the hologram element 200, in accordance with an example embodiment.

The hologram element 200 for broadband shaping of electromagnetic waves has a dispersive surface 210 with a surface height profile that is configured to spatially modulate an amplitude and/or a phase of transmitted electromagnetic waves (transmitted e.g. from the transceiver 110 of FIG. 1). The electromagnetic waves have a bandwidth that is defined by a start frequency f₁ and a stop frequency f₂.

In other words, the waves are directed towards the region of interest with a dispersive element, i.e. the hologram element 200. As a result, the modulated field is directed towards the region of interest while being dispersive at the same time. Thus, the region of interest is illuminated with a frequency-diverse spatially varying field. As discussed above, the system 100 comprises a single transceiver 110, which acquires the back reflection from the region of interest through the hologram element 200. When the illuminating field varies enough spatially across the bandwidth, the measured wide-band reflection will carry enough information to form an image 170 of the object 150, or to otherwise provide information about the object 150, such as localization information indicating a presence or absence of the object 150 in the region of interest.

For example, the electromagnetic waves may comprise radio waves in a millimeter wave band or in a submillimeter wave band. For example, the electromagnetic waves may comprise a frequency sweep or a pulse radiating across the bandwidth in question.

The surface height profile is further configured to maximize a rate of a phase shift or a delay variation at the bandwidth in question via steps 211₁, 211₂, . . . , 211_{X} comprised in the dispersive surface 210. Each step 211₁, 211₂, . . . , 211_{X} has an associated step height h₁, h₂, . . . , h_{X}. For the sake of clarity, only example step heights h₁, h₂, h₁₅, h₁₆, h₂₅ are indicated in FIG. 2, while example step heights h₃-h₁₄ and h₁₇-h₂₄ are represented by three dots symbols. The electrical length of each step height h₁, h₂, . . . , h_{X} is a multiple of N+q wavelengths at the start frequency f₁. Furthermore, the electrical length of each step height h₁, h₂, . . . , h_{X} is M multiple of wavelengths at the stop frequency f₂, such that:

M=(f₂/f₁)(N+q)=2(N+q),3(N+q),4(N+q)

in which q is a rational number representing a quantization step, and N is an integer.

Thus, the hologram element 200 may have a complex quasi-random surface relief, as illustrated in FIGS. 3A and 3B.

In other words, the hologram element 200 functions as a scattering element that has complex radio propagation paths that result in varying phase shifts as the transmitted radiation wavelength is changed. The result is complex frequency-dependent and time-dependent beamforming. A dispersive field may be created with e.g. a dielectric structure where the surface profile is modified in a predetermined way to maximize the change in radiation patterns across a given frequency band or temporal duration. In order to maximize the rate of the phase shift or delay variation at a given band pulse width, the step heights h₁, h₂, . . . , h_{X} of the surface height profile may be optimized to have an electrical length of N+q multiple of wavelengths at the sweep start frequency f₁ and M multiple of wavelengths at the stop frequency f₂, as described above.

For example, the hologram element 200 may be of a transmission type or a reflection type. For a transmission type hologram element 200, the radiation is transmitted from the bottom to the top in FIG. 2, and for a reflection type hologram element 200 the reflection occurs at the top of the element 200 in FIG. 2. A transmission type hologram element 200 may be of a dielectric material, e.g., cross-linked polystyrene. A reflection type hologram element 200 may be e.g. of aluminium.

For example, the step heights for two consecutive elevations may be defined as:

$${h}_{1} = \frac{( N + q ) {c}_{0}}{{f}_{1} \sqrt{{ε}_{r}}} and {h}_{2} = \frac{2 ( N + q ) {c}_{0}}{{f}_{1} \sqrt{{ε}_{r}}} ,$$

in which c₀ is the speed of light in a vacuum, and εᵣ is a relative dielectric permittivity of the material of the hologram element 200.

In other words, the step height h₁ and h₂ and the positions of the steps are optimized to achieve dispersive operation.

The surface height profile may be further configured such that the phase shift or delay variation is multiples of wavelengths different at different locations in order to allow the spatial modulation of the amplitude and/or the phase of the transmitted electromagnetic waves having the bandwidth in question.

The surface height profile may be further configured to facilitate transmitting the spatially modulated electromagnetic waves towards a region of interest within the bandwidth in question.

The surface height profile may be further configured to facilitate transmitting the spatially modulated electromagnetic waves towards a region of interest such that the electromagnetic waves are uniquely dependent on one of frequency or time at each location in the region of interest.

At least some of the embodiments described herein may allow imaging and/or localization of an object located in a region of interest.

At least some of the embodiments described herein may allow millimeter- and submillimeter-wave imaging and localization in real time without mechanical or active electrical control of multitude of phase shifters or transceivers to beam direction steering.

At least some of the embodiments described herein may allow imaging and/or localization e.g. in personnel screening, medical diagnosis (such as determining water content of a tissue), non-destructive testing, and/or inspecting thin film thicknesses, e.g., in an automobile paint surface in an automobile factory.

Existing millimeter wave scanning equipment is typically very large and heavy (up to approximately 200 kg in some cases). Furthermore, some existing millimeter wave scanning equipment may require cryogenic cooling down to less than 10 degrees Kelvin. Compared to such existing millimeter wave scanning equipment, at least some of the embodiments described herein may allow a scanning equipment that is fast, small, and inexpensive. For example, the diameter of a hologram element 200 suitable for personnel screening (i.e. allowing a scanning distance of approx. three meters) is less than half a meter. At least some of the embodiments described herein may allow a hand-held contactless scanning equipment.

Compared to metal detectors, at least some of the embodiments described herein may allow detecting not only metals but other materials also.

Any range or device value given herein may be extended or altered without losing the effect sought. Further, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples, and data provide a complete description of the structure and use of example embodiments. Although various embodiments have been described above with a certain degree of particularity, or with reference to one or more individual embodiments, those skilled in the art could make numerous alterations to the disclosed embodiments without departing from the scope of this specification.

1. A hologram element for broadband shaping of electromagnetic waves, comprising:
a dispersive surface with a surface height profile configured to spatially modulate at least one of an amplitude or a phase of transmitted electromagnetic waves having a bandwidth defined by a start frequency f1 and a stop frequency f2; wherein
the surface height profile is further configured to maximize a rate of one of a phase shift or a delay variation at said bandwidth via steps comprised in the dispersive surface, each step having a step height, the electrical length of which is a multiple of N+q wavelengths at the start frequency f1 and M multiple of wavelengths at the stop frequency f2, such that:
M=(f_2/f_1)(N+q)=2(N+q),3(N+q),4(N+q)
in which q is a rational number representing a quantization step, and N is an integer.

2. The hologram element according to claim 1, wherein the surface height profile is further configured such that the phase shift or delay variation is multiples of wavelengths different at different locations in order to allow the spatial modulation of said at least one of the amplitude or the phase of the transmitted electromagnetic waves having said bandwidth.

3. The hologram element according to claim 1, wherein the surface height profile is further configured to facilitate transmitting the spatially modulated electromagnetic waves towards a region of interest within said bandwidth.

4. The hologram element according to claim 1, wherein the surface height profile is further configured to facilitate transmitting the spatially modulated electromagnetic waves towards a region of interest such that the electromagnetic waves are uniquely dependent on one of frequency or time at each location in the region of interest.

5. The hologram element according to claim 1, wherein the hologram element (200) is of a transmission type or a reflection type.

6. The hologram element according to claim 1, wherein the electromagnetic waves comprise radio waves in a millimeter wave band or in a submillimeter wave band.

7. The hologram element according to claim 1, wherein the electromagnetic waves comprise a frequency sweep or a pulse radiating across said bandwidth.

8. A system comprising:
the hologram element according to claim 1; and
a transceiver configured to transmit the electromagnetic waves towards the hologram element and to receive the spatially modulated electromagnetic waves reflected from an object in the region of interest, wherein the electromagnetic field of the reflected spatially modulated electromagnetic waves is dependent on at least one of time or frequency in a way characteristic to a shape and reflectivity of the object in the region of interest.

9. The system according to claim 8, further comprising program code configured to determine a reflectivity image of the object in the region of interest based on the received reflected spatially modulated electromagnetic waves.

10. A hologram element for broadband shaping of electromagnetic waves, comprising:
a dispersive surface with a surface height profile configured to spatially modulate a phase of transmitted electromagnetic waves having a bandwidth defined by a sweep start frequency f1 and a sweep stop frequency f2; wherein
the surface height profile is further configured to maximize a rate of a phase shift at said bandwidth via steps comprised in the dispersive surface, each step having a step height the electrical length of which is a multiple of N+q wavelengths at the sweep start frequency f1 and M multiple of wavelengths at the sweep stop frequency f2, such that:
M=(f_2/f_1)(N+q)
in which q is a quantization step.
